(19) United States
(12) Patent Application Publication
(10) Pub. No.: US 2009/0252563 A1
(43) Pub. Date: Oct. 8, 2009

(54) APPARATUS AND METHOD UTILIZING BUOYANCY

(76) Inventor: Michael Raymond Gillespie, Worcestershire (GB)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/375,489

(22) PCT Filed: Jul. 30, 2007
(86) PCT No.: PCT/GB07/02892

§ 371 Date: Jan. 28, 2009

(30) Foreign Application Priority Data
Jul. 29, 2006 (GB) 0615149.2
Mar. 1, 2007 (GB) 0703930.8

(51) Int. Cl. B65G 53/30; F03B 17/04

(52) U.S. Cl. 406/106

(57) ABSTRACT

A tower structure (2) for raising an object (6) introduced to the tower structure (2) at an operative lower end thereof to an operative upper end thereof by buoyancy of the object (6) in liquid contained in the tower structure. The object (6) exits from the tower structure at the operative upper end and is displaceable by the force of gravity acting on the object for returning the object 6 to a lower level for return to the tower structure via an entrance arrangement. The entrance arrangement includes an inlet chamber (53) for receiving the object and a ram (28) for transferring the object from the inlet chamber (53) into the tower structure 2. The ram (28) separates the inlet chamber (53) from a ram chamber (62) and liquid is added to equalise the pressure in the chambers (53, 62) with that in the tower structure prior to actuating the ram (28) to insert the object (6) in the tower structure.

This invention concerns an apparatus and method utilising buoyancy. In particular, but not exclusively, the apparatus and method can be used to raise objects buoyant in a liquid to an elevated position from which the objects are lowered under the force of gravity acting on the objects.

According to one aspect of the invention, I provide apparatus comprising a tower structure for containing a fluid, the tower structure having an entrance arrangement near an operative lower end thereof through which an object, which is buoyant in the fluid, can enter the tower structure, and an exit arrangement near an operative upper end of the tower structure, through which an object can exit from the tower structure, means for receiving the object exiting from the tower structure via its exit arrangement and displaceable by the force of gravity acting on the object for returning the object to a lower level where it can separate from the receiving means for return to the tower structure via the entrance arrangement, the entrance arrangement including an inlet chamber for receiving an object separated from the receiving means, means for transferring an object from the inlet chamber into the tower structure, and means for admitting fluid to the inlet chamber.

According to another aspect of the invention, I provide a method of using buoyancy to lift an object comprising providing a tower structure containing fluid, providing an entrance arrangement for introducing objects buoyant in the fluid into the tower structure, providing an exit arrangement for transferring objects that have risen in the tower structure to a receiving device displaceable under the force of gravity acting on the objects to provide a source of energy from the gravitational potential energy of the objects wherein the entrance arrangement is provided with an inlet chamber for objects to be introduced into the tower structure and the method including the step of admitting fluid to the inlet chamber prior to transferring an object from the inlet chamber into the tower structure.

Preferably, the fluid is a liquid and more preferably water although other fluids in which the objects are buoyant may be employed including gases.

Preferably, the entrance arrangement includes a loading mechanism for transferring the object from the inlet chamber to the tower structure.

Preferably, the loading mechanism includes a ram movable between a retracted position in which an object can be loaded into the inlet chamber and an advanced position for transferring the object from the inlet chamber to the main tower structure. The ram may be electrically, hydraulically or pneumatically powered and may comprise a piston/cylinder device.

Preferably, the ram (piston) separates the inlet chamber from a ram chamber and both chambers contain fluid to assist movement of the ram. The fluid in the inlet chamber and ram chamber may be at substantially the same pressure as the fluid in the main tower structure. In this way pressure differentials within the system are reduced. As a result, operation of the loading mechanism is facilitated with reduced power requirements leading to greater efficiency.

Preferably, the ram chamber includes means for compensating for change in volume of the ram chamber as the ram (piston) moves between the retracted and advanced positions. The compensation means may comprise a control chamber and a control member operatively connected to the ram (piston) for movement into and out of the control chamber in response to displacement of the ram. The control member may be rotatable or slidable into and out of the control chamber.

Preferably, the entrance arrangement includes feed means for introducing objects returned from the tower structure into the inlet chamber. The feed means may include an indexing mechanism for introducing objects singly into the inlet chamber. Returned objects may be fed into the inlet chamber from above under gravity.

Embodiments of the apparatus and method according to the invention will now be described in more detail by way of example only with reference to the accompanying drawings wherein:

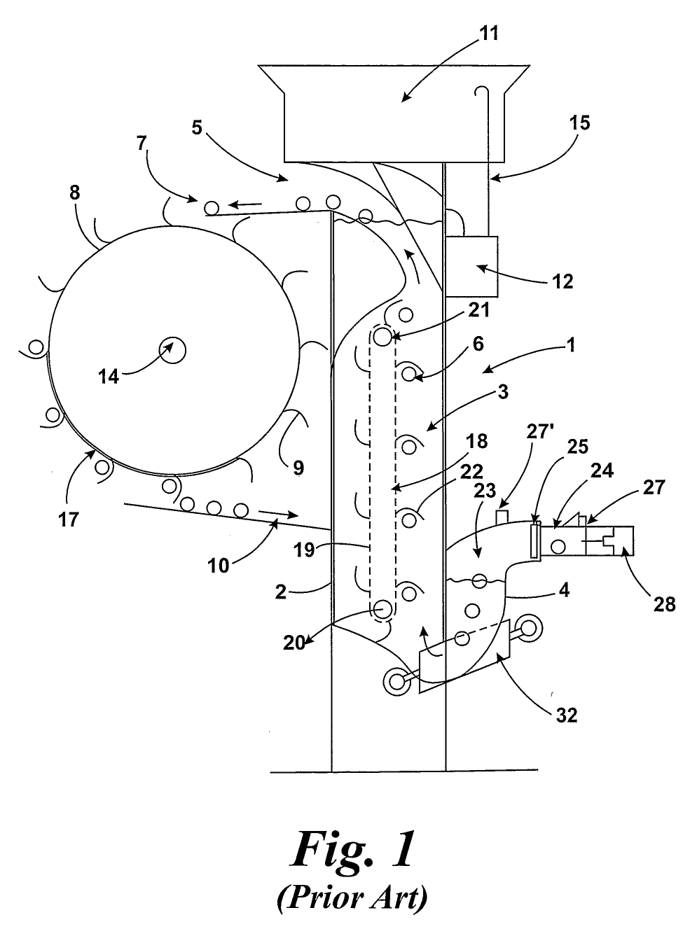

FIG. 1 is a schematic side view of known buoyancy apparatus; and

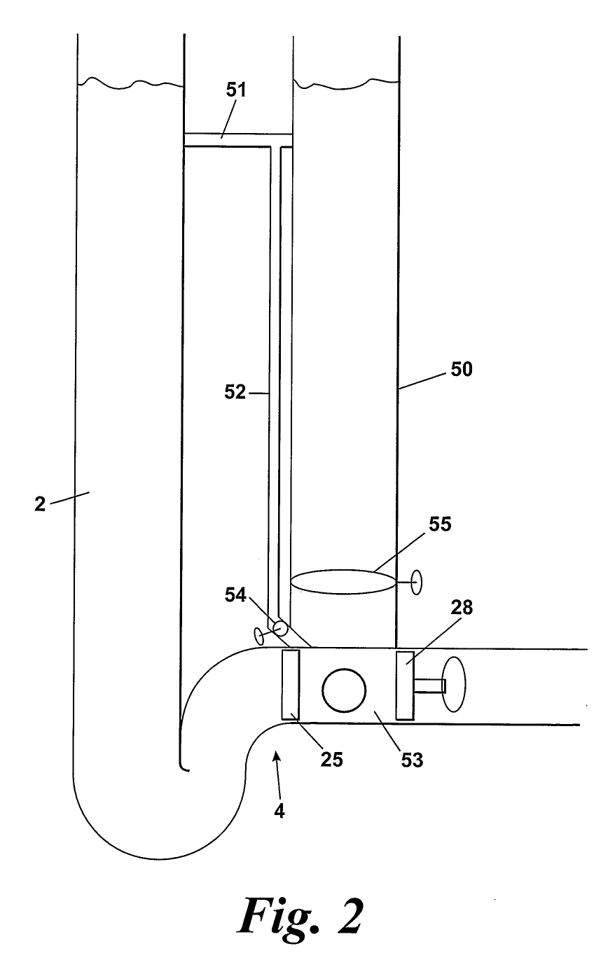

FIG. 2 is a schematic side view showing of buoyancy apparatus according to an embodiment of the invention.

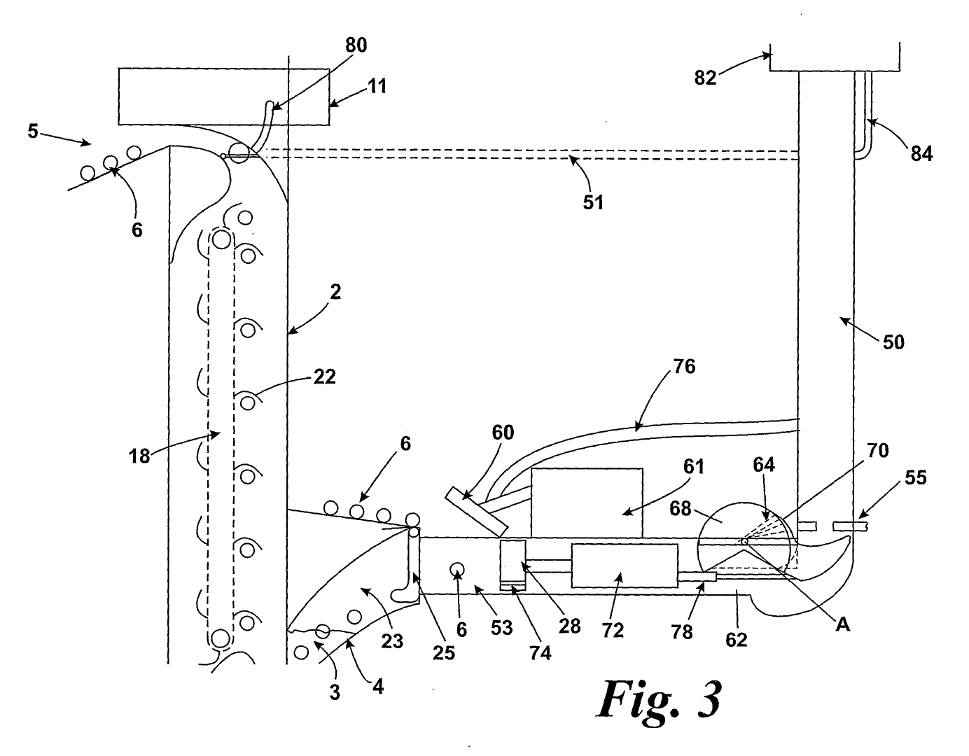

FIG. 3 is a schematic side view of buoyancy apparatus according to another embodiment of the invention;

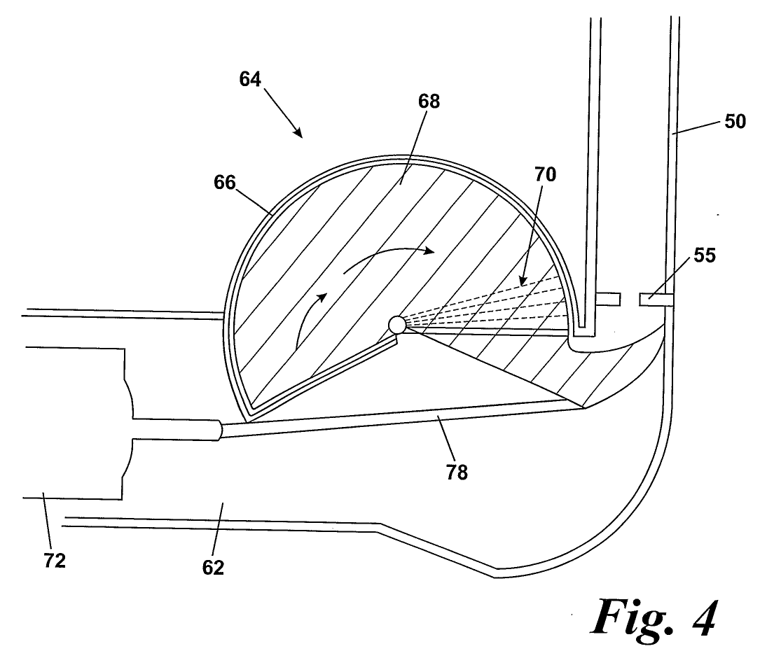

FIG. 4 shows, to an enlarged scale, a detail of the apparatus shown in FIG. 3;

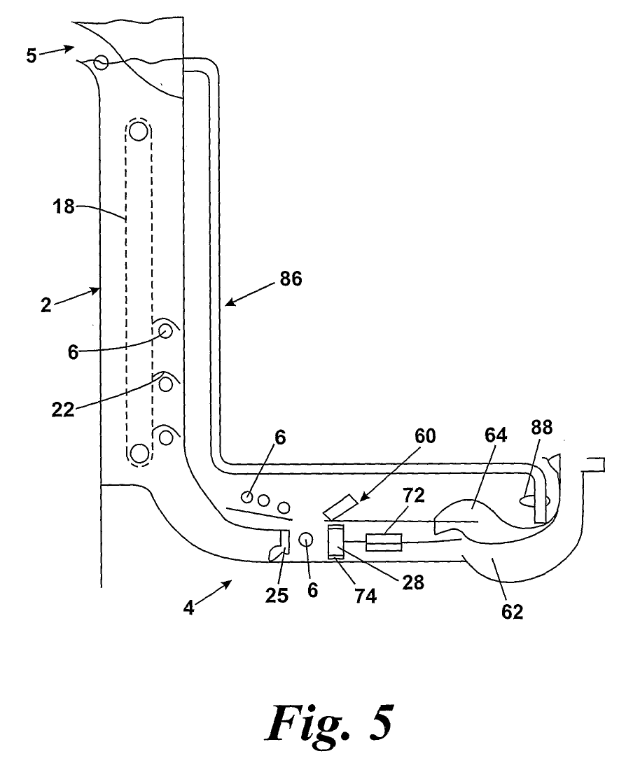

FIG. 5 is a schematic side view of buoyancy apparatus according to yet another embodiment of the invention; and

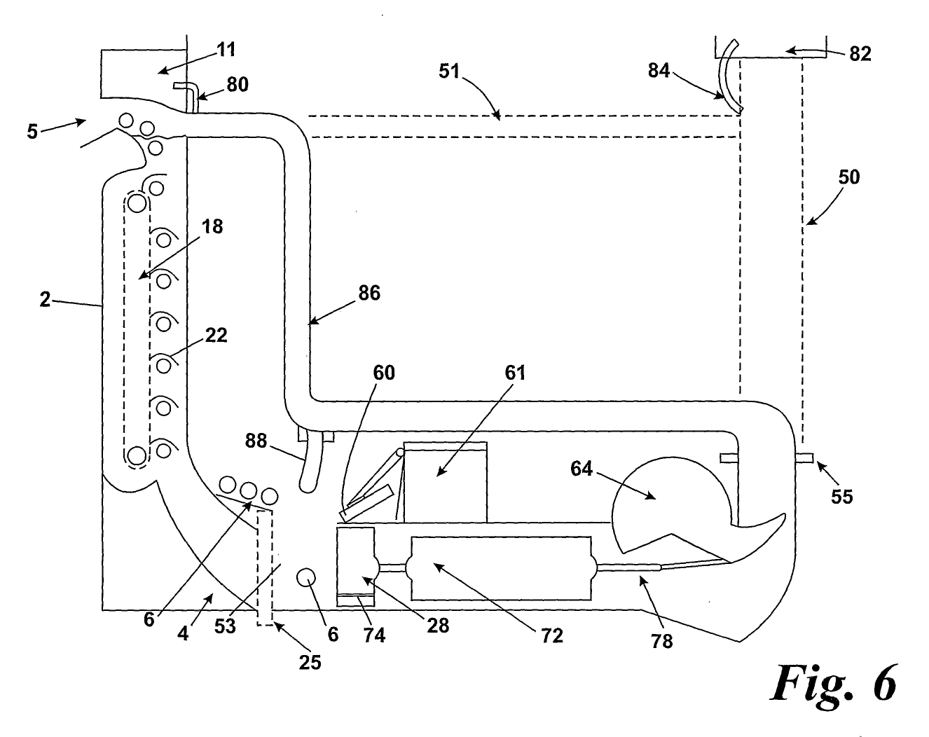

FIG. 6 is a schematic view of buoyancy apparatus according to still another embodiment of the invention.

Referring first to FIG. 1 of the drawings, known buoyancy apparatus described in my co-pending International patent application No. PCT/GB2006/002627 is shown.

The apparatus comprises a delivery system 1 for raising objects 6 to an elevated position. The delivery system 1 comprises a tower structure 2 that defines a path that contains liquid 3. Typically, the liquid is water however it will be understood that other suitable liquids may be used. The tower structure 2 is associated with an entrance arrangement 4 that receives objects 6 buoyant in the liquid 3 and an exit arrangement 5 that permits objects 6 that have been elevated to a position on the surface of the liquid 3 to be dispensed from an outlet 7.

Located on top of the tower structure 2 is a reserve liquid tank 11 that stores a reserve of liquid for topping up the liquid in the tower structure 2. A control valve (not shown) controls the flow of liquid from the tank 11 to the tower structure 2. An overflow tank 12 is also provided on the edge of the tower structure 2 to retain liquid if the surface level rises above a predetermined level. A return pipe 15 extends between the overflow tank 12 and reserve tank 11 such that liquid can be pumped from the overflow tank 12 to the reserve tank 11.

A collector device 18 is provided within the tower structure 2 for guiding objects 6 introduced into the tower structure 2 via the entrance arrangement 4 to the exit arrangement 5. The collector device 18 comprises retaining arms 22 attached to an endless belt 19 extending between two rollers 20, 21. The retaining arms 22 receive objects 6 entering into the tower structure 2 such that the buoyancy of the objects 6 in the liquid displaces the conveyor belt 19, rotating rollers 20,21.

The retaining arms 22 are buoyant in the liquid 3 and are hinged to the belt 19 for pivotal movement between an operative, generally horizontal position and an inoperative, generally vertical position. The arms 22 adopt the operative position for movement from the lower end to the upper end for collecting objects introduced into the tower structure and the inoperative position for movement from the upper end to the lower after releasing the objects.

In this way, the collector device 18 acts to control the ascent of objects 6 in the tower structure 2. Furthermore, the rollers 20, 21 can be connected to a shaft or gearing to provide a take-off for energy produced by the buoyancy of the objects 6 in the liquid 3. Any other suitable collector device 18 may be employed. Alternatively, the collector device 18 may be omitted.

A receiving device 17 is provided to lower objects 6 discharged from the upper end of the tower structure 2. The receiving device 17 comprises receiving arms 9 attached to the outer periphery of a wheel 8 having a shaft 14 supported for rotation. The arms 9 receive objects 6 discharged from the outlet 7 such that the force of gravity acting on the objects 6 rotates the wheel 8 to lower the objects 6 to a position at which the objects 6 are released and transferred to a feeder line 10. The shaft 14 may provide a take off for energy produced by the gravitational force acting on the objects. The shaft 14 could be connected to a gearing system (not shown) for stepping up or down to a required RPM (revolutions per minute). Alternatively or additionally, the outer circumference of the wheel may be connected to gearing to provide a take-off for energy produced by the gravitational force acting on the objects. Any other suitable receiving device may be employed.

The feeder line 10 extends from the bottom of the wheel 8 to the entrance arrangement 4 for returning objects 6 released from the wheel 8 to the entrance arrangement 4. In this embodiment, the objects 6 are cylindrical and the feeder line 10 has a cylindrical tube 10a sized to receive the objects 6. It will be understood the objects 6 and tube 10a may have other shapes.

The tube 10a is provided with a series of seals 29 and eyeball rollers 30 and the feeder line 10 is arranged such that a stack of objects 6 can be formed in the tube 10a with the rollers 30 aligning the objects 6 with the seals 29. The seals 29 engage the objects 6 in the stack to form a fluid tight seal at an inlet 26 to the entrance arrangement 4.

The entrance arrangement 4 has a pressure-balancing chamber 23 connected to an airlock chamber 24 by an inlet port provided with an airlock door 25. In the closed position, the door 25 provides a fluid tight seal between chamber 23 and chamber 24. The lower end of the tower structure 2 has a U-bend leading from pressure-balancing chamber 23. Pressure-balancing chamber 23 contains compressed air, or other gas, introduced through control valve 27′ to balance the pressure of the liquid in the tower structure 2. Maintaining the desired pressure in chamber 23 maintains the desired liquid levels in the tower structure 2. A shut-off valve 32 is provided at the bottom of tower structure 2 to close off the pressure-balancing chamber 23 from the rest of the tower structure 2 when the system is not in use.

Airlock chamber 24 receives objects 6 from feeder line 10 through inlet 26 and a ram 28 is provided to push objects 6 from the airlock chamber 24 through door 25 into chamber 23. An air control valve 27 is provided for controlling the flow of air into and out of the airlock chamber 24 and the inlet 26 can be sealed in a fluid tight manner as described previously to allow the chamber 24 to be pressurised prior to opening the door 25. Retaining arms 31 hold objects 6 in place in the feeder tube 10a and resist forces produced when the airlock chamber 24 is pressurised urging the objects 6 from the feeder line 10.

Operation of the buoyancy system will now be described. Objects 6 are fed into feeder line 10 to form a stack of objects sealing the inlet 26 to the airlock chamber 24. Once feeder line 10 is full, pushing another object 6 into the feeder line 10 forces one or more of the objects 6 at the head of the stack into chamber 24. At this point, airlock chamber 24 is depressurised such that objects 6 can be easily forced into the chamber 24.

Once one or more objects 6 are located in chamber 24, compressed air is forced into the airlock chamber 24 to equalise the pressure in chamber 24 with that in pressure balance chamber 23. Once the pressures are substantially equal, the ram 28 is operated to force the object 6 through door 25 into pressure balance chamber 23.

Objects 6 pushed into pressure balancing chamber 23 stack up around the U-bend until the object 6 at the head of the stack is forced into the main part of the tower structure 2. The object 6 then rises up the tower structure 2 engaging retaining arms 22 on the endless belt 19. This displaces the belt 19 rotating rollers 20,21. This rotation of the rollers 20,21 provides a source of energy that can be used to drive other systems via a suitable power take-off.

The arms 22 of the collector device 18 guide and control the ascent of the objects 6 in the tower structure 2 and deliver the objects to the exit arrangement 5 where the objects 6 are dispensed from the tower structure 2 onto the wheel 8. The weight of the objects 6 on the wheel 8 causes rotation of the wheel 8. This rotation of the wheel and/or shaft 14 provides a source of energy that can be used to drive other systems via suitable take-off of power generated by the wheel 8.

When objects 6 reach a location near the bottom of the wheel 8 they are released into feeder line 10 for return to the entrance arrangement 4. This provides for reinsertion of objects 6 into the tower structure 2 allowing circulation of the objects 6 in the system.

The energy provided by the system can be used for generating electricity or for enabling the operation of various other mechanical devices that require mechanical power for their operation.

The apparatus according to the present invention is an improvement of the apparatus shown in FIG. 1. The improvement is shown in FIG. 2. For convenience and ease of understanding other parts of the apparatus are not shown in FIG. 2. It will be understood, however that the apparatus operates in a similar manner to raise objects in a tower structure using buoyancy and then to lower the objects under gravity for return to the tower structure wherein the raising and/or lowering of the objects can be utilised to provide a power source.

In this modified version of the apparatus, the control valve for controlling flow of air into and out of the air-lock chamber is omitted. In place of the control valve, a second tower structure 50 is provided in fluid communication with the main tower structure 2 by a connector pipe 51 just below the upper level of the water in the main tower structure 2 and a feed pipe 52 extends from the connector pipe 51 to inlet chamber 53. A valve 54 controls admission of water to the inlet chamber 53 from the feed pipe 52.

In use, an object 6 is inserted in the inlet chamber 53 as described previously. At this point, the valve 54 is closed to prevent water entering the inlet chamber 53. Once the object is located in the chamber 53, the valve 54 is opened to introduce water into the chamber 53. In this way, the pressure in chamber 53 and the pressure in the tower structure 2 can be substantially equalised and the valve 54 closed enabling the door 25 separating the chamber 53 from the tower structure 2 to be opened and the object 6 pushed into the tower structure 2 with the ram 28. The water in the chamber 53 also enters the tower structure 2 at the same time. The door 25 is then closed allowing another object 6 to be inserted into the inlet chamber 53 and the above cycle repeated to insert the object 6 into the tower structure 2.

As shown, in this embodiment, the tower structure 50 is provided with a valve 55 at the lower end that can be opened to added water to the chamber 53. The valve 55 permits a higher flow than the valve 54 and can be used to provide faster filling of the chamber 53 with water. By providing two valves for admitting water to the chamber 54, one valve can be used as a back-up if the other valve fails.

As will be appreciated, using the water in the tower structure to pressurise the inlet chamber and returning the water to the tower structure 2 with the object 6 inserted into the tower structure 2 is particularly energy efficient. It will be understood, however, that other sources of water and/or arrangements for adding water to the chamber 53 can be employed.

Referring now to FIGS. 3 and 4 of the drawings, another embodiment of apparatus according to the invention is shown in which parts corresponding to the apparatus of FIGS. 1 and 2 are given the same reference numerals. For convenience and ease of understanding some parts of the apparatus shown in FIG. 1 are not shown in FIGS. 3 and 4. It will be understood, however that the apparatus operates in a similar manner to raise objects in a tower structure using buoyancy and then to lower the objects under gravity for return to the tower structure wherein the raising and/or lowering of the objects can be utilised to provide a power source.

In the modified form of the apparatus shown in FIGS. 3 and 4, the inlet chamber 53 is provided with a door 60 in the upper wall. The door 60 is movable by a drive mechanism 61 including a power pack between a closed position (not shown) sealing the chamber 53 and an open position allowing an object 6 from feeder line 10 to drop into the chamber 53 under gravity after which the door 60 can be closed to enable the chamber 53 to be filled with water prior to admitting the object 6 to the main tower structure 2. An indexing mechanism (not shown) may be provided so that the objects 6 are fed into the chamber 53 in a controlled manner, one at a time.

The second tower structure 50 has a control valve 55 or valves at the lower end for admitting water to a ram chamber 62 for assisting movement of the ram 28. The ram chamber 62 is provided with a water displacement mechanism 64 including a control chamber 66 and a rotatable control member 68 to compensate for the change in volume of the ram chamber 62 as the ram 28 is displaced to urge the object 6 in the inlet chamber 53 into the main tower 2. The control chamber 66 comprises an arcuate segment and the control member 68 is rotatable about an axis A in response to axial displacement of the ram 28 into and out of the control chamber 66 according to the direction of movement of the ram 28. The ram 28 is shown in its fully retracted (withdrawn) position in FIGS. 3 and 4 at the start of the insertion cycle when the door 60 is open to allow the next object 6 to be inserted into the inlet chamber 53. In this position, the control member 68 is housed in the control chamber 66.

The ram 28 is movable between the retracted position and an advanced position (not shown) in which the ram 28 is displaced to left as viewed in FIG. 3 by a drive mechanism 72 including a power pack. The ram 28 is provided with a one-way valve 74 or valves that allows water to flow from the ram chamber 62 into the inlet chamber 53 to fill the inlet chamber 53 at the start of each cycle but prevent water flowing back into the ram chamber 62 as the ram 28 is advanced to urge the object 6 into the main tower structure. Alternatively or additionally, the inlet chamber 53 may be filled with water introduced into the chamber 53 via a feed line 76 from the second tower structure by-passing the ram chamber 62. The member 68 is coupled to the ram 28 by a drive arm 78 to rotate the member 68 about axis A in response to displacement of the ram 28.

In operation, at the start of the insertion cycle, with the main entrance door 25 closed and the ram 28 retracted, the door 60 is opened to allow the next object 6 to be inserted into the inlet chamber 53 by the indexing mechanism. The object 6 falls into the chamber 53 under gravity and is cushioned by water introduced into the chamber 53 via the one-way valve 74 as the ram 28 is retracted or via the by-pass line 76 from the second tower structure 50 before the door 60 is opened to introduce the object. After the object 6 is introduced, the door 60 is closed to seal the chamber 53 and equalise the pressure in the inlet chamber 53 and the ram chamber 62 with the pressure in main tower structure 2. As a result, the door 25 separating the inlet chamber 53 from the main tower structure 2 can be opened and the ram 28 advanced to push the object 6 into the main tower structure 2. As the ram 28 advances, the member 68 rotates in a clockwise direction and emerges from the control chamber 66 to compensate for the increase in volume of the ram chamber 62 as the ram 28 moves to the left as viewed in FIG. 3. Seals 70 prevent water entering the control chamber 66 as the member 68 emerges and allow the member 68 to return to its original position when the ram is withdrawn to its retracted position. In this way, the volume of water required to fill the ram chamber 62 does not change as the ram 28 moves and the pressure in the ram chamber 62 is maintained so that the pressure across the ram 28 is balanced thereby reducing the force required to displace the ram 28 to insert the object 6 into the main tower structure. As will be appreciated, reducing the insertion force reduces the power requirements allowing a lower rated drive motor to be employed in the drive mechanism for the ram and improving efficiency. After the object 6 is inserted into the main tower structure, the ram 28 is withdrawn causing the member 68 to rotate in a counter clockwise direction and return into the chamber 66. The door 60 to the inlet chamber 53 can then be opened to insert the next object 6 and repeat the cycle as described above. Line 51 connects the main tower structure 2 to the second tower structure 50 to maintain the same water level in both structures 2,50 thereby equalising pressures within the system. The water level in the main tower structure 2 is maintained by adding water from storage tank 11 at the upper end of the main tower structure 2 under the control of a float operated valve 80. Likewise, water can be added to the second tower structure via a storage tank 82 at the upper end of the second tower structure 50 and a feed line 84 controlled by a suitable valve (not shown).

The water displacement mechanism 64 may comprise rotatable control member 68 as described or a slidable control member or any other suitable device for compensating for change in volume of the ram chamber 62. The control member 68 may emerge from the control chamber 66 in a clockwise direction as described or an anticlockwise direction by appropriate connection to the ram 28.

Referring now to FIG. 5, a further embodiment of the invention is shown in which the same reference numerals are used to indicate parts corresponding to previous embodiments.

In this embodiment, a pipe 86 connects the upper end of the main tower structure 2 to the ram chamber 62 and valve 88 controls addition of water to the ram chamber 62. The U-bend at the lower end of the main tower structure 2 is omitted and the door 25 connects the inlet chamber 53 for inserting objects 6 into the lower end of the main tower structure 2 where ascent of the objects 6 due to buoyancy is controlled by the collector device 18 as described previously.

This embodiment operates in similar manner to the previous embodiment, where water is added to the ram chamber 62 and the water displacement mechanism 64 assists movement of the ram 28 to transfer the object 6 from the inlet chamber 53 to the main tower structure 2. The door 25 into the main tower structure may be of any suitable construction, for example a sliding gate. Water is admitted to the inlet chamber 53 via the non-return valve in the ram 28. Alternatively or additionally, water may be admitted to the inlet chamber 53 via a pipe (not shown) connected to the pipe 86.

Referring now to FIG. 6, a further embodiment of the invention is shown in which like reference numerals are used to indicate parts corresponding to previous embodiments.

This embodiment is similar to the embodiment shown in FIG. 5 modified to include a second tower structure 50 similar to previous embodiment shown in FIG. 3.

In this embodiment, the pipe 86 connects the upper end of the first tower structure to the lower end of the second tower structure and includes a pipe 88 for adding water to the inlet chamber 53. The operation of this embodiment will be understood from the description of the previous embodiments.

In the above-described embodiments, the objects 6 are buoyant in water contained in the main tower structure 2 and water is also used in other parts of the system to assist introduction of the objects 6 into the main tower structure 2 to reduce power requirements and improve efficiency. It will be understood, however, that the main tower structure may contain any fluid—liquid or gas or mixtures thereof—in which the objects 6 are buoyant and the same or different fluid may be used to assist introduction of the objects into the main tower structure 2.

It will also be appreciated that the invented arrangement for inserting the objects into the tower structure can be employed in any apparatus using buoyancy of the object in a fluid contained in a tower structure to raise the object and is not limited to the apparatus described in my co-pending International patent application the description of which is provided herein by way of example only of such apparatus to facilitate a complete understanding of the apparatus and method of the present invention.

Other modifications that can be made will be apparent to those skilled in the art.

1. Apparatus comprising a tower structure for containing a fluid, the tower structure having an entrance arrangement near an operative lower end thereof through which an object, which is buoyant in the fluid, can enter the tower structure, and an exit arrangement near an operative upper end of the tower structure, through which an object can exit from the tower structure, means for receiving the object exiting from the tower structure via its exit arrangement and displaceable by the force of gravity acting on the object for returning the object to a lower level where it can separate from the receiving means for return to the tower structure via the entrance arrangement, the entrance arrangement including an inlet chamber for receiving an object separated from the receiving means, means for transferring an object from the inlet chamber into the tower structure, and means for admitting fluid to the inlet chamber.

2. Apparatus according to claim 1 wherein, the entrance arrangement includes a loading mechanism for transferring the object from the inlet chamber to the tower structure.

3. Apparatus according to claim 2 wherein, the loading mechanism includes a ram movable between a retracted position in which an object can be loaded into the inlet chamber and an advanced position for transferring the object from the inlet chamber to the main tower structure.

4. Apparatus according to claim 3 wherein, the ram is an electrically, hydraulically or pneumatically powered piston/cylinder device.

5. (canceled)

6. Apparatus according to claim 1 including a second tower structure.

7. Apparatus according to claim 6 including a fluid connection between the first tower structure and the second tower structure.

8. (canceled)

9. (canceled)

10. (canceled)

11. (canceled)

12. Apparatus according to claim 3 wherein, the ram separates the inlet chamber from a ram chamber and both chambers contain fluid to assist movement of the ram.

13. Apparatus according to claim 12 wherein, fluid in the inlet chamber and ram chamber is at substantially the same pressure as the fluid in the main tower structure.

14. Apparatus according to claim 12 wherein, the ram chamber includes means for compensating for change in volume of the ram chamber as the ram moves between the retracted and advanced positions.

15. Apparatus according to claim 14 wherein the compensation means comprises a control chamber and a control member operatively connected to the ram for movement into and out of the control chamber in response to displacement of the ram.

16. Apparatus according to claim 15 wherein the control member is rotatable or slidable into and out of the control chamber.

17. Apparatus according to claim 12 wherein the ram includes a valve operable to admit fluid from the ram chamber to the inlet chamber as the ram moves towards the retracted position.

18. Apparatus according to claim 12 wherein a second tower structure is provided for admitting fluid to the ram chamber and/or the inlet chamber.

19. (canceled)

20. (canceled)

21. Apparatus according to claim 18 including a fluid connection between the first and second tower structures.

22. (canceled)

23. Apparatus according to claim 21 wherein the fluid connection extends between an upper end of the first tower structure and the second tower structure.

24. Apparatus according to claim 18 wherein the or each tower structure is provided with a storage tank and means for adding fluid from the storage tank to the tower structure.

25. Apparatus according to claim 1 wherein, the entrance arrangement includes feed means for introducing objects returned from the tower structure into the inlet chamber.

26. Apparatus according to claim 25 wherein, the feed means includes an indexing mechanism for introducing objects singly into the inlet chamber.

27. Apparatus according to claim 25 wherein returned objects are fed into the inlet chamber from above under gravity.

28. A method of using buoyancy to lift an object comprising providing a tower structure containing fluid, providing an entrance arrangement for introducing objects buoyant in the fluid into the tower structure, providing an exit arrangement for transferring objects that have risen in the tower structure to a receiving device displaceable under the force of gravity acting on the objects to provide a source of energy from the gravitational potential energy of the objects wherein the entrance arrangement is provided with an inlet chamber for objects to be introduced into the tower structure and the method including the step of admitting fluid to the inlet chamber prior to transferring an object from the inlet chamber into the tower structure.

29. A method according to claim 28 wherein, the fluid is a liquid.

30. A method according to claim 28 including the step of providing a ram separating the inlet chamber from a ram chamber and equalizing pressure in the inlet chamber and ram chamber with the pressure in the tower structure prior to transferring an object from the inlet chamber to the tower structure with the ram.
